(19) United States
(12) Patent Application Publication
(10) Pub. No.: US 2007/0217443 A1
(43) Pub. Date: Sep. 20, 2007

(54) Communication apparatus, communication method, and computer program product

(76) Inventors: Kazuyuki Sakoda, Tokyo (JP); Kenzoh Nishikawa, Kanagawa (JP); Erika Saito, Tokyo (JP); Chihiro Fujita, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/709,738

(22) Filed: Feb. 23, 2007

(30) Foreign Application Priority Data
Mar. 3, 2006 (JP) 2006-058563

(51) Int. Cl. H04L 12/66

(52) U.S. Cl. 370/463

(57) ABSTRACT

A communication apparatus that performs data transmission on a medium according to the packet switching system includes an upper-layer processing unit that performs processing of data to be transmitted, a Phy processing unit that manages an operation of physical access to the medium, and a media-access-control processing unit that generates a transmission packet, instructs the Phy processing unit to transmit the packet, and performs control for access to the medium. The media-access-control processing unit includes a buffer memory, a transmission buffer list, and a header-information generating unit. The media-access-control processing unit instructs the Phy processing unit to transmit a preamble signal, starts generation processing for the header information by the header-information generating means, and instructs the Phy processing unit to transmit, before the transmission of the preamble signal is finished, the header information generated.

### CROSS-REFERENCES TO RELATED APPLICATIONS

The present invention contains subject matter related to Japanese Patent Application JP 2006-058563 filed in the Japanese Patent Office on Mar. 3, 2006, the entire contents of which being incorporated herein by reference.

### BACKGROUND OF the INVENTION

1. Field of the Invention

The present invention relates to a communication apparatus, a communication method, and a computer program product for performing data transmission according to a packet switching system, and, more particularly to a communication apparatus, a communication method, and a computer program product for starting packet transmission processing before transmission contents are decided at the time of data transmission.

2. Description of the Related Art

In a communication system of a stored-and-forward switching type, data is temporarily stored in a stored-and-forward switching machine when the data is transmitted. The stored-and-forward switching machine finds an optimum medium and performs data transmission. In this case, unlike the circuit switching system, since the medium is not exclusively used, it is possible to efficiently use the medium among plural communication stations. The packet switching system is adopted in most of this kind of communication systems. Transmission data is assembled in a transmission unit called a packet and transmitted and received among the communication stations. According to this transmission system, there are advantages that, since routing is performed in a unit of packet, efficiency of use of a medium is high and data transmission and reception is possible among terminals having different communication speeds. Further, since resend control and error control are performed in a unit of packet, throughput is high. Present computer networks such as a network of IEEE802 are basically established by the packet switching system.

Recently, a radio network is rapidly spreading as a communication system that releases a user from cable wiring among apparatuses by the wire system. For example, as a typical standard concerning a wireless LAN, there is IEEE802.11. A packet format prescribed in IEEE802.11a is shown in FIG. 4. As shown in the figure, a packet is formed by a preamble including packet finding and a known training sequence for acquiring synchronization timing, a PLCP (Physical Layer Convergence Protocol) header serving as a Phy header, and a PSDU (Physical Layer Service Data Unit) serving as a Phy payload.

A RATE field indicating a transmission rate of the PSDU, a LENGTH field indicating the length of the PSDU, a parity bit, and a SIGNAL field in which a Tail bit of an encoder is described are stored in the PLCP header.

The PSDU is equivalent to a MAC frame. Several frame types are defined in IEEE802.11. Frame formats for four kinds of frames, i.e., RTS, CTS, ACK, and DATA, among the frame types are shown in FIG. 8. ACK is a frame format for acknowledgement returned to a transmission source by a communication station that has safely received a packet. RTS and CTS are frame formats used for a procedure for requesting data transmission and obtaining consent to the data transmission between transmission and reception stations (described later). In both the frames, a Frame Control field and a Duration field are commonly defined in a MAC header. Information indicating types, uses, and the like of the frames is stored in the Frame Control field. Time until a series of transactions concerning the packets end is described in the Duration field as medium reservation information used for a NAV (Network Allocation Vector).

The Data frame includes, other than the above, four address fields Addr1 to Addr4 for specifying a transmission source, a destination communication station, and the like, a sequence field (SEQ), a Frame Body, which is net information provided to an upper layer, and an FCS (Frame Check Sequence), which is a checksum.

The RTS frame includes, other than the above, a Receiver Address (RA) indicating a destination, a Transmitter Address (TA) indicating a transmission source, and an FCS, which is a checksum. The CTS frame and the ACK frame include, other than the above, an RA indicating a destination and an FCS, which is a checksum.

In forming a wireless LAN, a method of forming a network under the collective control by a control station called an “access point” or a “coordinator” in an are a is generally used. However, when asynchronous communication is performed between terminals, efficiency of use of a transmission line is reduced by half. Therefore, in the wireless LAN system of IEEE802.11, an ad-hoc mode in which the system operates peer to peer in an autonomous and delivered manner is prepared. As a methodology for solving a hidden terminal problem in an ad-hoc network, a CSMA/CA system by an RTS/CTS procedure is applied. According to the CSMA/CA system, a communication apparatus can prevent collision by starting information transmission of the communication apparatus after confirming that other communication apparatuses are not performing information transmission. In the RTS/CTS system, a communication station at a data transmission source transmits a transmission request packet RTS (Request To Send) and starts data transmission in response to reception of an acknowledgement notification packet CTS (Clear To Send) from a communication station at a data transmission destination.

Actions that could occur in peripheral stations when the RTS/CTS procedure is performed between transmission and reception stations are illustrated in FIG. 5. In the figure, there are four communication stations, namely, STA2, STA0, STA1, and STA3. As a communication environment, it is assumed that only communication stations adjacent to each other in the figure are located in the coverage of a radio wave. It is assumed that the communication station STA0 desires to transmit information to the communication station STA1.

The communication station STA0 at a transmission source confirms that a medium is clear for a fixed period (until time T11) according to a procedure of CSMA and then transmits an RTS packet from time T11 to the communication station STA1. Information indicating that the packet is RTS is described in Type information of a Frame Control field of the RTS packet. Time until this packet transmission and reception transaction ends (i.e., time until time T18) is described in a Duration field. An address of the destination communication station STA1 is described in an RA field. An address of the communication station STA0 itself is described in a TA field.

The RTS packet is also received by the communication station STA2 located near the communication station STA0. When the communication station STA2 receives an RTS signal, the communication station STA2 decodes a PSDU on the basis of information obtained by decoding a PLCP header. The communication station STA2 recognizes from the Frame Control field in the PSDU that the packet is the RTS packet and recognizes from the RA field that the communication station STA2 itself is not the destination communication station. Then, the communication station STA2 sets a NAV and stops a transmission operation for a period indicated by the Duration field not to prevent the transmission desire of the communication station STA0.

The communication station STA1, which is the destination of the RTS packet, decodes the PSDU to recognize that the communication station STA0 desires to transmit data packet to the communication station STA0 itself. Then, the communication station STA1 returns a CTS packet at time T13 at a short frame interval (SIFS). In a Frame Control field of a PSDU of the CTS packet, an indication that the packet is a CTS packet is described. Time until this transaction ends (i.e., time until time T18) is described in a Duration field. An address of the destination communication station STA1 is described in an RA field.

The CTS packet is also received by the communication station STA3 located near the communication station STA1 at the transmission destination. The communication station STA3 decodes the PSDU on the basis of information obtained by decoding a PLCP header. The communication station STA3 recognizes from the Frame Control field in the PSDU that the packet is a CTS packet and recognizes from the RA field that the communication station STA3 itself is not a destination communication station. Then, the communication station STA3 sets a NAV over a period indicated by the Duration field not to prevent the reception desire of the communication station STA1.

The communication station STA0, which is the destination of the CTS packet, decodes the PSDU to recognize that the communication station STA1 is prepared for reception. Then, the communication station STA0 starts transmission of a Data packet at time T15 at an SIFS interval. When the transmission of the Data packet ends at time T16 and the communication station STA1 successfully decodes the Data packet, the communication station STA1 returns an ACK at time T17 at the SIFS interval. The communication station STA0 receives the ACK and the transmission and reception transaction of one packet ends at time T18. At time T18, the communication stations STA2 and STA3 release the NAV and return to the normal transmission and reception state.

In this way, according to the RTS/CTS communication system, a hidden terminal can set an appropriate transmission stop period and prevent collision with data transmission by a station near the hidden terminal.

A structure of a communication apparatus that performs data communication according to the packet switching system is schematically shown in FIG. 6. The communication apparatus shown in the figure includes an upper-layer processing unit 10 equivalent to an application that performs processing of data to be transmitted, a MAC processing unit 20 that performs control for access to a medium and control for resend of a packet, and a Phy processing unit 30 that manages an operation for physical access to the medium.

The MAC processing unit 20 includes a transmission-data processing unit that performs exchange of transmission data between the MAC processing unit 20 and the upper-layer processing unit 10 and a buffer memory 21 that temporarily stores transmission data and reception data. At the time of data transmission, the transmission-data processing unit slices a payload section from the transmission data stored in the buffer memory 2 and generates header information to perform processing for generating a packet. Specifically, the transmission-data processing unit reads out the transmission data from the buffer memory and extracts length information to decide a value of LENGTH in a SIGNAL field. Further, the transmission-data processing unit calculates, on the basis of values of RATE and LENGTH, duration that should be described in a DURATION field in the MAC header. When contents of the transmission packet are decided, the transmission-data processing unit passes the transmission packet to the Phy processing unit 30. The Phy processing unit 30 generates a physical transmission signal and transmits the physical transmission signal to a partner side from a medium.

It is possible to constitute the transmission-data processing unit using, for example, a microprocessor of a one-chip type. The transmission-data processing unit can realize the generation of transmission data and the like according to software processing. A flow of this processing is illustrated in FIG. 7. In software using a real-time operating system (RTOS), when transmission packet generation processing is started, contents processed to that point are retracted to a heap area. Then, the start of a new task is executed and preparation for execution of the processing is performed. Thereafter, the transmission-data processing unit reads out the transmission data from the buffer memory (S01) and executes extraction of length information of the transmission packet and calculation of transmission duration in time series (S02). The transmission-data processing unit judges whether this data may be actually transmitted (S03) and then performs update of the duration information and the length information (S04) to generate transmission header information.

There is known a communication system that multiplexes contents of two or more packets on one transmission frame (see, for example, Japanese Patent Application No. 2004-300675 already assigned to this applicant). For example, it is possible to substantially reduce an amount of overhead that occurs in a MAC layer by including information having different purposes such as RTS, CTS, DATA, and ACK in one packet. The time-series processing in S01 to S04 is processing performed for one transmission data. In S03, the transmission-data processing unit judges whether other data should further be multiplexed. In S04, the transmission-data processing unit recalculates duration information and length information by multiplexing the data. When plural data are described in one packet by multiplexing and transmission of the plural data is attempted at a time, this time-series processing is executed repeatedly by the number of the transmission data.

It is anticipated that emergency processing interrupts the transmission packet generation processing according to a function provided by the RTOS. In such a case, a procedure for retracting contents of the transmission packet generation processing presently performed to the heap are a, starting a task of the emergency processing, and, after completing the processing, restoring the retracted data and returning to the transmission packet generation processing is executed. It is difficult to unconditionally estimate time taken until the transmission packet generation processing is completed. Usually, a processing delay at a level of several hundred microseconds has to be estimated.

An interface between the Phy processing unit 30 and the MAC processing unit 20 is considered. Operations performed between the Phy processing unit 30 and the MAC processing unit 20 when a packet of the frame format shown in FIG. 4 is transmitted are traced.

There is a processing delay from the time when the MAC processing unit 20 instructs the Phy processing unit 30 to transmit the packet until a signal is sent to a medium. Referring to a lower section in FIG. 5, when time T1 is start time of the packet transmission, the MAC processing unit 20 notifies the Phy processing unit 30 of preamble transmission at time T0 prior to time T1 by the processing delay taking into account the processing delay. Thereafter, in the same manner, the MAC processing unit 20 passes SIGNAL information and PSDU information to the Phy processing unit 30 prior to transmission time by processing delay times T2 and T4, respectively.

In a time chart shown at the bottom in FIG. 4, when the MAC processing unit 20 instructs transmission of a preamble at time T0, the MAC processing unit 20 has to complete header information (SIGNAL) of a transmission packet by time T2. However, as explained with reference to FIG. 7, the transmission packet generation processing by the software takes time. This processing time is extended by multiplexing the transmission data. When the processing time is long, the processing is easily affected by the emergency processing. In order to prevent a situation in which the header information is not completed by time T2, it is appropriate to instruct transmission of the preamble after generation of the transmission packet is completed rather than starting the transmission packet generation processing after instructing transmission of the preamble at time T0. In this case, it is necessary to determine respective fields from information in a PHY header to a PSDU by time T0 when transmission of the packet is started.

When the transmission processing is started after generation of the transmission packet is completed, this is disadvantageous in acquiring a transmission right for accessing a medium at random. When data transmission is started through the RTS/CTS procedure described above, in order to describe the Duration information in the RTS packet, the communication terminal at the transmission source needs to determine even contents of a following data packet at a point when the RTS packet is transmitted. In this way, since it is necessary to determine contents of the transmission packet before transmitting the packet, it is difficult to transmit the packet at desired time because of a processing delay until transmission contents are decided after a transmission request is sent from an upper layer.

For example, there is proposed a packet communication method in which redundant information of header sections of plural communication packets are omitted, the header sections are coupled to form a header section of a transmission frame, and payload sections of the plural transmission packets are coupled to form a payload section of the transmission frame to reduce overheads on the payload section of the transmission frame and realize efficiency of transmission and improvement of a communication quality (see, for example, JP-A-10-247942). However, since the header section is not decided until the coupling of the payload sections is finished, eventually, it is difficult to solve the problem described above.

### SUMMARY OF the INVENTION

Therefore, it is desirable to provide an excellent communication apparatus, communication method, and computer program product that can suitably perform data transmission according to the packet switching system.

It is also desirable to provide an excellent communication apparatus, communication method, and computer program product that can start packet transmission processing before transmission contents are decided at the time of data transmission.

According to an embodiment of the invention, there is provided a communication apparatus that performs data transmission on a medium according to the packet switching system. The communication apparatus includes an upper-layer processing unit that performs processing of data to be transmitted, a Phy processing unit that manages an operation of physical access to the medium, and a media-access-control processing unit that generates a transmission packet, instructs the Phy processing unit to transmit the packet, and performs control for access to the medium. The media-access-control processing unit includes a buffer memory that temporarily stores the transmission data, which the upper-layer processing unit requests to transmit, a transmission buffer list that holds attribute information concerning respective transmission data stored in the buffer memory, and header-information generating means for generating header information of the transmission packet with reference to the transmission buffer list. The media-access-control processing unit instructs the Phy processing unit to transmit a preamble signal according to storage of the transmission data in the buffer memory, starts generation processing for the header information by the header-information generating means, and instructs the Phy processing unit to transmit, before the transmission of the preamble signal is finished, the header information generated.

The embodiment of the invention relates to a communication apparatus that performs data transmission according to the packet switching system. Specifically, the communication apparatus performs a communication operation conforming to IEEE802.11.

The transmission packet generation processing can be realized by, for example, software processing under an execution environment provided by a real-time OS in a processor. However, a processing time for packet generation is extended by multiplexing the transmission data. The processing is affected by interrupt by emergency processing because of a function provided by the RTOS. Therefore, to perform transmission of the header information without delay from the preamble transmission, it is difficult to start a transmission operation before contents of the transmission packet are decided.

In such a case, in performing data transmission in accordance with the RTS/CTS procedure, it is necessary to determine, at a point when an RTS packet is transmitted, even contents of a following data packet. Therefore, it is difficult to transmit the packet at desired time because of a processing delay until transmission contents are decided after a transmission request is sent from an upper layer.

On the other hand, the communication apparatus according to the embodiment of the invention starts transmission of the preamble at a stage when only rough information such as a type of a packet, data rate information, and duration in which transmission is permitted is decided, determines contents of the header information such as a SIGNAL field and a MAC header during the preamble transmission, and performs transmission of the transmission packet.

Therefore, in transmitting a signal to be transmitted prior to data transmission of the RTS or the like, only the rough information such as a type of a packet is decided in advance. Until transmission timing for a header section comes, details such as the number and a total duration of data attempted to be transmitted and contents stored in a PSDU section of the RTS packet only have to be decided.

In other words, it is possible to transmit the packet before transmission contents are decided and transmit the packet in a short time after a transmission request is sent from an upper layer.

This makes it possible to transmit the packet at desired time and transmit a packet including complicated contents in a short time.

The communication apparatus according to the embodiment of the invention includes, as a media-access-control processing unit that performs processing in a MAC layer, a buffer memory that temporarily stores transmission data, which the upper-layer processing unit requests to transmit, a transmission buffer list that holds attribute information concerning respective transmission data stored in the buffer memory, and header-information generating means for generating header information of a transmission packet with reference to the transmission buffer list.

The media-access-control processing unit instructs the Phy processing unit to transmit a preamble signal according to storage of the transmission data in the buffer memory, starts generation processing for the header information by the header-information generating means, and instructs the Phy processing unit to transmit, before the transmission of the preamble signal is finished, the header information generated.

The transmission buffer list holds, as attribute information of the transmission data, a destination address, a transmission data rate, and a type of a packet format. In a communication system to which the CSMA/CA system by the RTS/CTS procedure is applied, information of any one of RTS, CTS, DATA, and ACK is held as the type of a packet format of the transmission data.

The transmission buffer list also holds a data length as the attribute information of the transmission data. The media-access-control processing unit further includes duration calculating means for calculating duration necessary for a transmission operation for the transmission data on the basis of the transmission data rate and the data length. The header-information generating means can describe, as a part of the header information, media reservation information (Duration) used for an access according to the CSMA/CA on the basis of a result of the calculation by the duration calculating means.

There is a communication method of multiplexing plural transmission data on one packet and substantially reducing an amount of overhead that occurs in the MAC layer. In multiplexing contents of two or more transmission data on one packet, the duration calculating unit calculates duration every time transmission data is added. The header-information generating means only has to cumulatively add up data lengths of the respective transmission data multiplexed on the packet and update contents of header information on the basis of a result of the calculation by the duration calculating means.

According to the embodiment of the invention, it is possible to provide an excellent radio communication apparatus, radio communication method, and computer program product that can suitably perform data transmission according to the packet switching system.

According to the embodiment of the invention, it is possible to provide an excellent radio communication apparatus, radio communication method, and computer program product that can, in particular, start packet transmission processing before transmission contents are decided at the time of data transmission.

Further objects, characteristics, and advantages of the invention will be made apparent by more detailed explanations based on an embodiment of the invention described later and the accompanying drawings.

### BRIEF DESCRIPTION OF THE DRAWINGS

FIG. 1 is a diagram schematically showing a functional structure of a communication apparatus according to an embodiment of the invention;

FIG. 2 is a diagram showing an internal structure of a header-information generating unit 23;

FIG. 3 is a diagram showing, on a time axis, a state of generation of respective fields of a transmission packet;

FIG. 4 is a diagram showing a packet format in IEEE802.11a;

FIG. 5 is a diagram for explaining actions that could occur in peripheral stations when a RTS/CTS procedure is performed between transmission and reception stations;

FIG. 6 is a diagram schematically showing a structure of a communication apparatus that performs data communication according to a packet switching system;

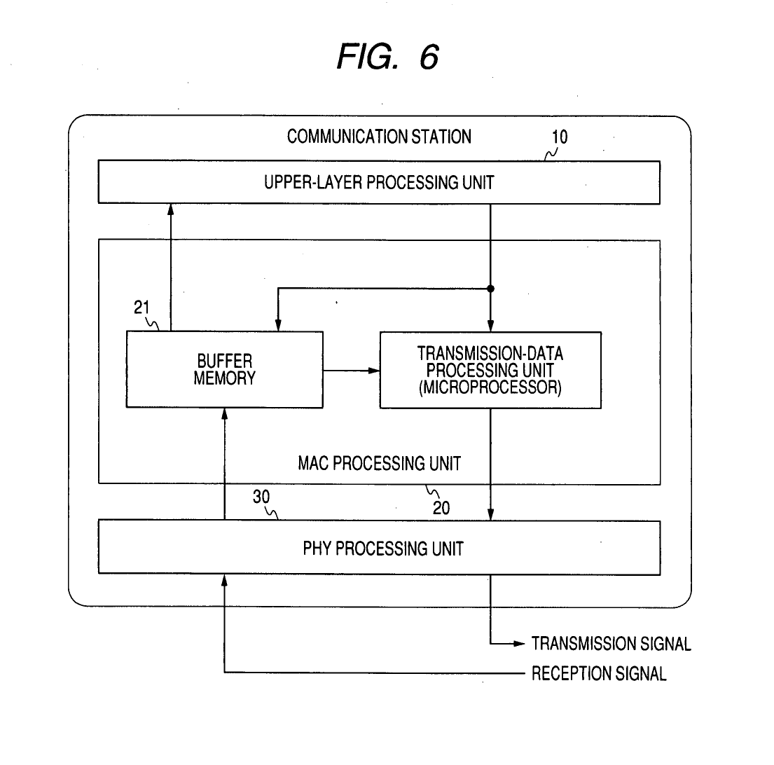

FIG. 7 is a diagram for explaining a procedure for realizing generation of transmission data according to software processing; and

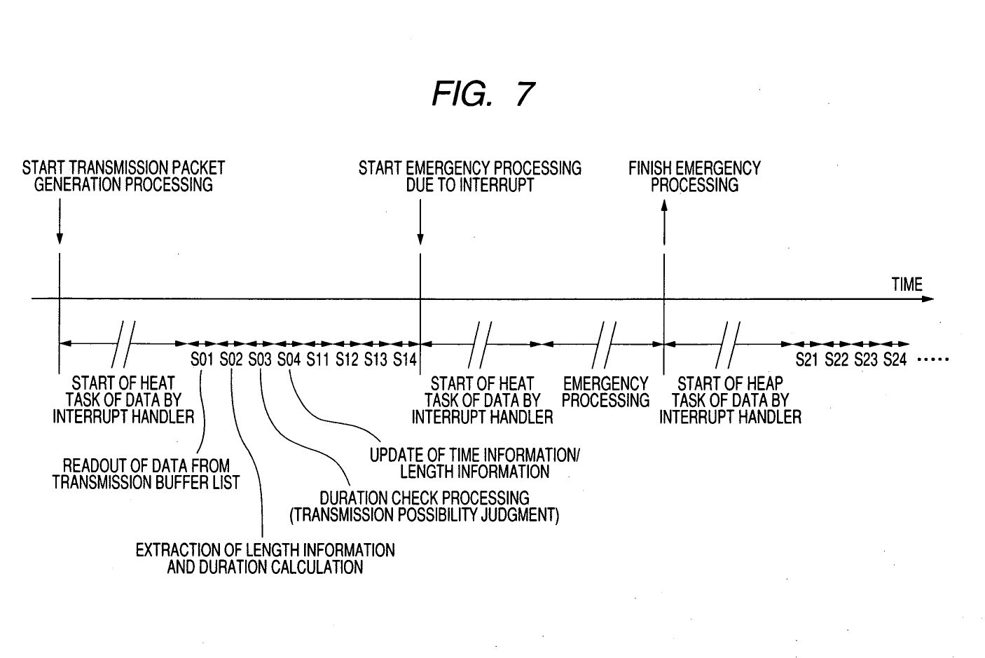

FIG. 8 is a diagram showing frame formats for four kinds of frames, i.e., RTS, CTS, ACK, and DATA.

### DESCRIPTION OF THE PREFERRED EMBODIMENTS

An embodiment of the invention will be herein after explained in detail with reference to the accompanying drawings.

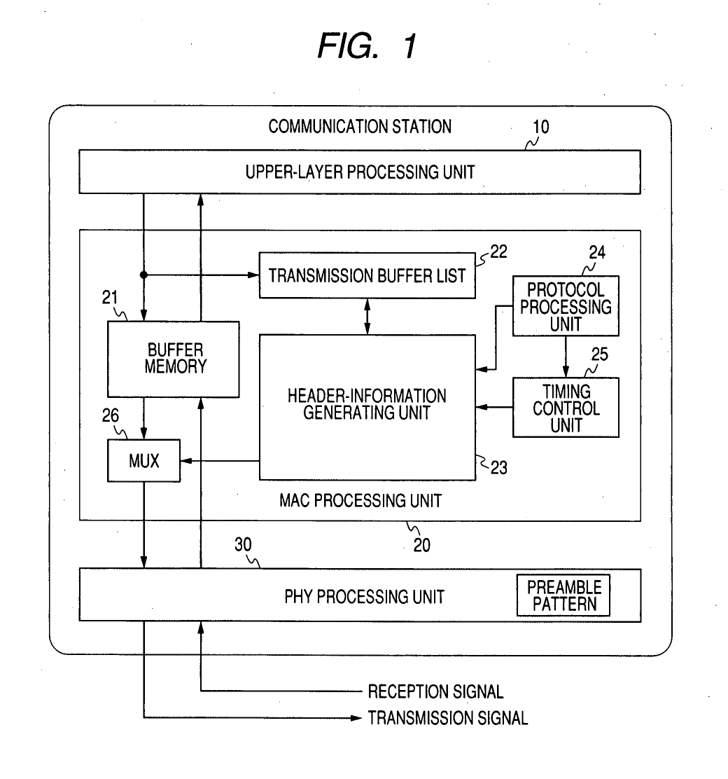

The embodiment of the invention relates to a communication apparatus that performs data transmission according to the packet switching system. Specifically, the communication apparatus can perform a communication operation conforming to IEEE802.11. A functional structure of a communication apparatus according to an embodiment of the invention is schematically shown in FIG. 1. The communication apparatus shown in the figure includes an upper-layer processing unit 10 equivalent to an application that performs processing of data to be transmitted, a MAC processing unit 20 that performs control for access to a medium and control for resend of a packet, and a Phy processing unit 30 that manages an operation for physical access to the medium.

In FIG. 1, mainly paying attention to a data transmission operation, an internal structure of the MAC processing unit 20 is shown. The MAC processing unit 20 includes a buffer memory 21 that temporarily stores transmission data passed from the upper-layer processing unit 10, a transmission buffer list 22 that stores data lengths and other attribute information of respective data stored in the buffer memory 21, a header-information generating unit 23 that generates header information of a transmission packet, a protocol processing unit 24 for realizing a transmission operation based on a communication protocol such as the RTS/CTS, a timing control unit 25 that determines transmission timing for a packet by calculating a frame interval (IFS) and back-off, and a multiplexer 26 that extracts transmission data from the buffer memory 21 and multiplexes the transmission data on the header information generated by the header-information generating unit 23 to assemble a transmission packet.

When transmission data is given to the MAC processing unit 20 from the upper-layer processing unit 10, contents of the data are stored in the buffer memory 21 and, at the same time, an indication that the data is stored anew is registered in the transmission buffer list 22.

The transmission buffer list 22 is formed by a list structure and stores attribute information such as the length of the transmission data. When there is data that should be transmitted continuously following a part of head data that should be transmitted, an address where information of the data that should be transmitted continuously is stored is described in the transmission buffer list 22.

The header-information generating unit 23 is means for determining contents of a packet to be transmitted. The header-information generating unit 23 outputs header information of the transmission packet, an address of a transmission data memory, and the like.

In transmitting a packet, first, the MAC processing unit 20 starts the header-information generating unit 23 and determines contents of the transmission packet. Then, the MAC processing unit 20 outputs header information to the Phy processing unit 30 and subsequently extracts an entity of the data from the buffer memory 21 and outputs the entity of the data to the Phy processing unit 30. The output of the header information and the entity of the data is performed in the multiplexer 26.

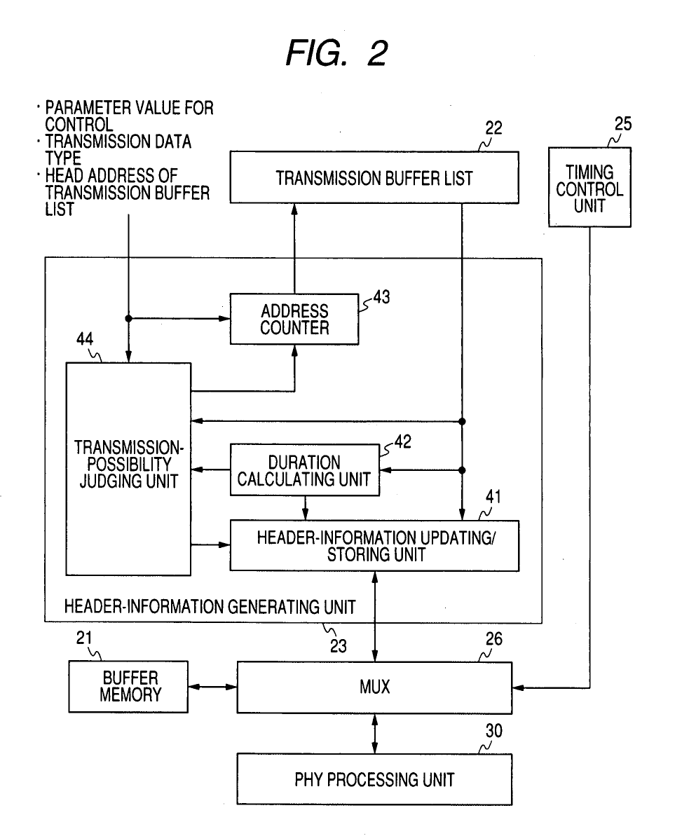

An internal structure of the header-information generating unit 23 is shown in FIG. 2. The header-information generating unit 23 shown in the figure includes a header-information updating/storing unit 41, a duration calculating unit 42, an address counter 43, and a transmission-possibility judging unit 44.

Information such as parameters necessary in transmitting a packet, a type of transmission data, and address information indicating the head of the transmission buffer list 22 are inputted to the header-information generating unit 23 from the upper-layer processing unit 10.

The header-information generating unit 23 can access the transmission buffer list 22 in a form same as the normal access to a RAM using the address counter 43. When the address information is given to the transmission buffer list 22, the transmission buffer list 22 can output transmission data information stored in an address corresponding to the address information to the header-information updating/storing unit 41 and read out information necessary for generation of header information of the transmission packet.

The duration calculating unit 42 calculates duration necessary for packet transmission on the basis of a data length of the transmission data read out from the transmission buffer list 22 and outputs a result of the calculation to the header-information updating/storing unit 41. In multiplexing plural data on one packet, the duration calculating unit 42 recalculates duration every time data is added and the header-information updating/storing unit 41 updates contents of the header information.

The transmission-possibility judging unit 44 accesses the transmission buffer list 22 via the address counter 43, checks whether data that should be transmitted continuously is present with reference to attribute information concerning the transmission data, and judges whether the data may be transmitted.

The header-information updating/storing unit 41 generates a PLCP header (or a Phy header) and a MAC header on the basis of the attribute information of the transmission data read out from the transmission buffer list 22 and the duration information calculated by the duration calculating unit 42 and updates contents of the headers as appropriate. When the transmission-possibility judging unit 44 judges that the packet may be transmitted, the header-information updating/storing unit 41 outputs the stored header information to the multiplexer 26.

The multiplexer 26 reads out transmission data corresponding to the header information from the buffer memory 21 to form a Frame Body of a PSDU. In addition, the multiplexer 26 adds the header information supplied from the header-information updating/storing unit 41 to the transmission data to generate a transmission packet and passes the transmission packet to the Phy processing unit 30 in accordance with timing determined by the timing control unit 25. The protocol processing unit 24 instructs the timing control unit 25 to control transmission timing when a response packet is transmitted because of the packet reception or when transmission data is generated. For example, in the CSMA system, the timing control unit 25 gives a trigger for packet transmission when a media access is not detected for a predetermined frame interval (IFS) or after standby for a random back-off time.

A specific procedure for generating a transmission packet will be explained in detail.

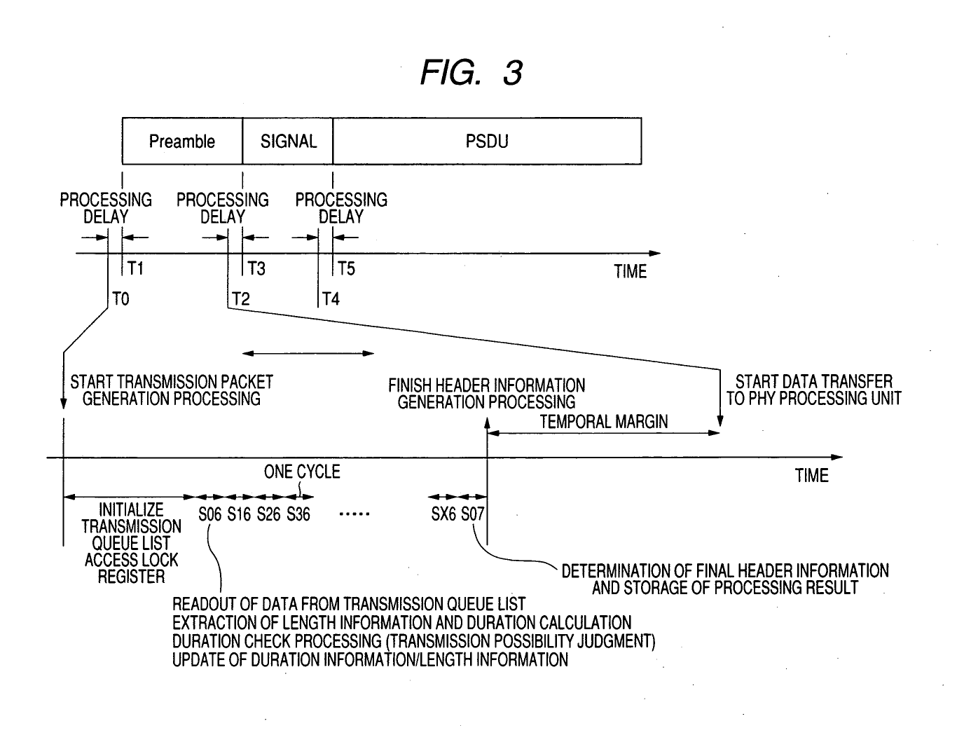

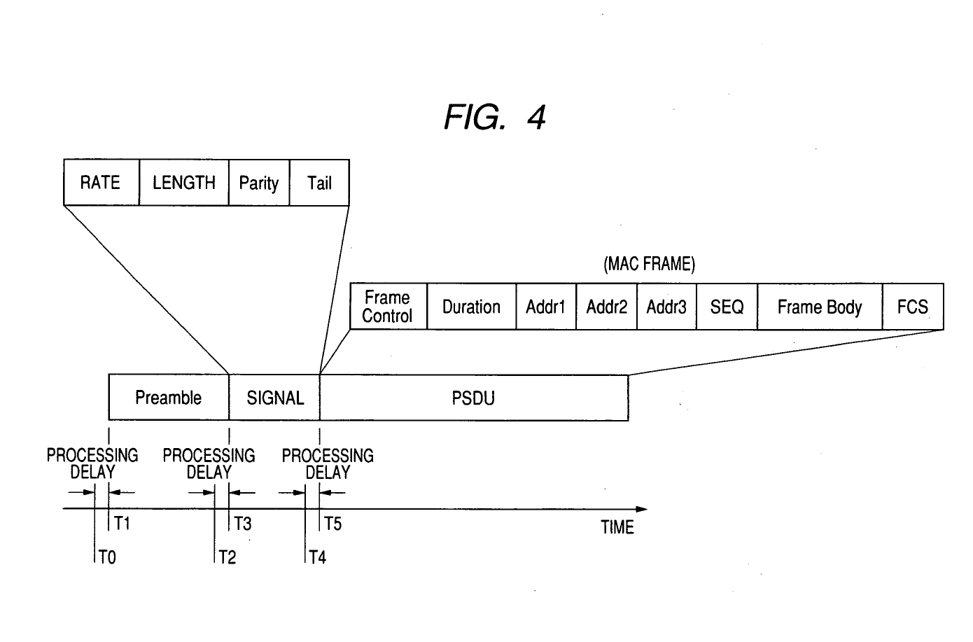

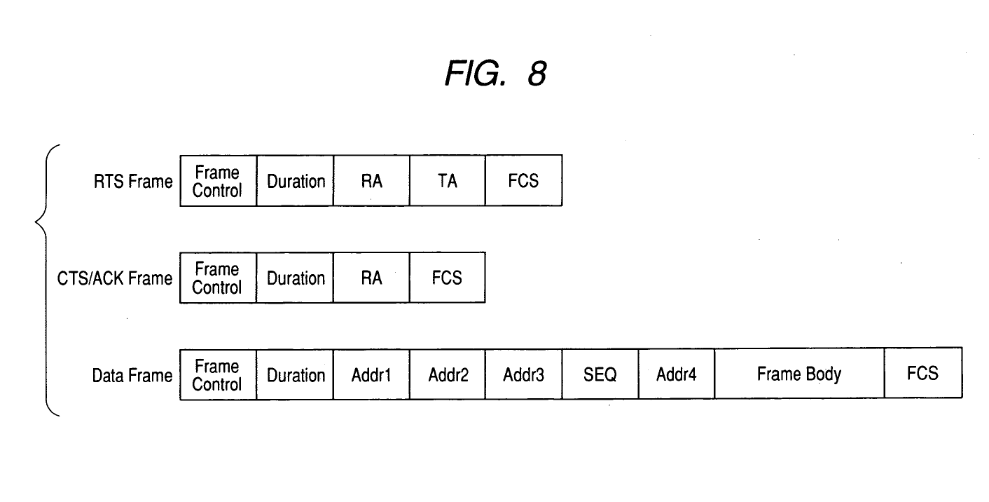

A state of generation of respective field of a transmission packet having the format shown in FIG. 4 is shown on a time axis in FIG. 3. First, a packet transmission procedure in the case in which a MAC frame is DATA (see FIG. 8) will be explained with reference to FIG. 3.

In attempting to transmit a packet, at time T0, the MAC processing unit 20 instructs the Phy processing unit 30 to perform preamble transmission and starts processing in the header-information generating unit 23. At the start of transmission of the packet, it is sufficient to determine only a type of the transmission packet (specifically, a destination address, a transmission data rate, and any one of RTS, CTS, DATA, and ACK). It is unnecessary to decide contents of the transmission packet. In this case, values of parameters for control are simultaneously decided. As the parameters for control, a maximum duration that may be used for transmission by the local station, a maximum bit length that can be transmitted by the packet, and the like are given.

When the MAC processing unit 20 is notified of the start of the processing, the MAC processing unit 20 declares to not-shown other processing circuit modules that an exclusive access right to the transmission buffer list 22 is acquired and performs preparation for accessing the transmission buffer list 22. Moreover, the MAC processing unit 20 decides, from the destination address and the like of the transmission packet, a head address to the transmission buffer list 22. The MAC processing unit 20 initializes registers used in the processing for determining contents of the transmission packet and initializes header information generation processing for the transmission packet.

The address counter 43 outputs an address in which transmission data information read out from the transmission buffer list 22 is stored. The address counter 43 outputs addresses, in which the next data in a transmission waiting state are stored, one after another on the basis of the data described in the transmission buffer list 22. The transmission buffer list 22 outputs information of data strings in a transmission waiting state one after another according to address inputs from the address counter 43.

When the initialization processing is finished, from the next processing cycle, attribute information of the transmission data in the transmission waiting state is inputted to the header-information generating unit 23 from the transmission buffer list 22. The duration calculating unit 42 calculates duration necessary in transmitting the data from a transmission data rate given as a parameter and length information of the data outputted from the transmission buffer list 22 and outputs the duration to the transmission-possibility judging unit 44.

The header-information updating/storing unit 41 cumulatively adds up the length information of the transmission data supplied from the transmission buffer list 22 and generates and stores header information of the packet, for example, holds the length of the entire packet.

The transmission-possibility judging unit 44 judges whether the transmission data outputted from the transmission buffer list 22 may be transmitted with the packet. When it is judged that it is possible to transmit the transmission data as a processing object with the packet, the transmission-possibility judging unit 44 instructs the address counter 43 to read out the next transmission data from the transmission buffer list 22. Conversely, when it is judged that it is difficult to transmit the transmission data as a processing object with the packet, the transmission-possibility judging unit 44 determines to form a transmission packet using data up to transmission data immediately preceding the transmission data and finishes processing for generating header information.

When the length of an entire transmission packet exceeds an allowable maximum value given by a parameter, transmission duration exceeds an allowable maximum value given by a parameter, or the number of transmission data exceeds a maximum allowable value given by a parameter, the transmission-possibility judging unit 44 judges that it is difficult to transmits the transmission data with the packet. The transmission-possibility judging unit 44 also finishes the processing for generating header information of the packet when it is judged that no more transmission data is stored according to information obtained from the transmission buffer list 22.

Since the processing is simultaneously executed by plural processing circuit modules, it is possible to complete the processing in one cycle for one transmission data. In other words, after initialization, it is possible to execute processing concerning N transmission data in N cycles. In the example of the state shown in FIG. 3, processing for transmission data is completed once in S06, S16, S26, and the like and X−1 (when there is no more transmission data, X) transmission data are finally transmitted.

When the processing for generating header information concerning all transmission data as transmission objects is finished, the processing for generating header information is finally finished through processing for determining final header information and storing a result of the processing in the header-information updating/storing unit 41 (S07).

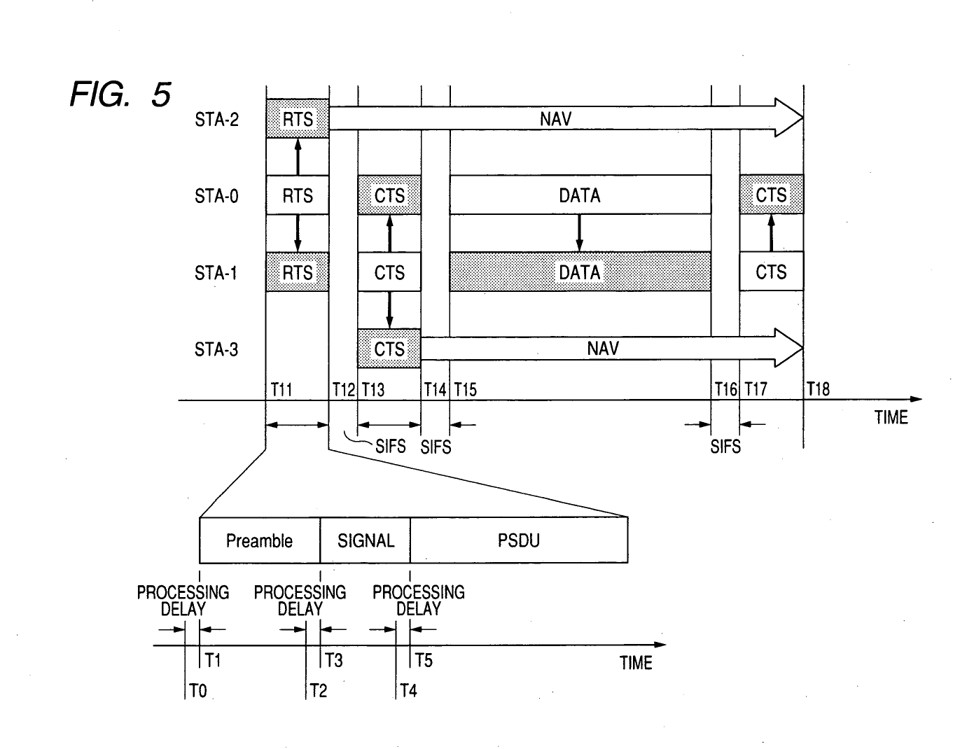

As explained in the section of “Description of the Related Art”, in IEEE802.11, the CSMA/CA system by the RTS/CTS procedure is applied in order to prevent collision of communication stations and solve the problem of a hidden terminal under the ad-hoc mode. In this case, a data transmission station transmits an RTS packet prior to a data packet (see FIG. 5). This packet has a format of a MAC frame different from that of the data packet (see FIG. 8). Thus, in the following description, a packet transmission procedure in transmitting the RTS packet will be explained with reference to FIG. 3.

In attempting to transmit a packet, at time T0, the MAC processing unit 20 instructs the Phy processing unit 30 to perform preamble transmission and starts processing in the header-information generating unit 23. At the start of transmission of the packet, it is sufficient to determine only a type of the transmission packet (specifically, a destination address, a transmission data rate, and any one of RTS, CTS, DATA, and ACK). It is unnecessary to decide contents of the transmission packet. In this case, values of parameters for control are simultaneously decided. As the parameters for control, a maximum duration that may be used for transmission by the local station, a maximum bit length that can be transmitted by the packet, and the like are given.

When the MAC processing unit 20 is notified of the start of the processing, the MAC processing unit 20 declares to not-shown other processing circuit modules that an exclusive access right to the transmission buffer list 22 is acquired and performs preparation for accessing the transmission buffer list 22. Moreover, the MAC processing unit 20 decides, from the destination address and the like of the transmission packet, a head address to the transmission buffer list 22. The MAC processing unit 20 initializes registers used in the processing for determining contents of the transmission packet and initializes header information generation processing for the RTS packet.

The address counter 43 outputs an address in which transmission data information read out from the transmission buffer list 22 is stored. The address counter 43 outputs addresses, in which the next data in a transmission waiting state are stored, one after another on the basis of the data described in the transmission buffer list 22. The transmission buffer list 22 outputs information of data strings in a transmission waiting state one after another according to address inputs from the address counter 43.

When the initialization processing is finished, from the next processing cycle, attribute information of the transmission data in the transmission waiting state is inputted to the header-information generating unit 23 from the transmission buffer list 22. The duration calculating unit 42 calculates duration necessary in transmitting the data from a transmission data rate given as a parameter and length information of the data outputted from the transmission buffer list 22 and outputs the duration to the transmission-possibility judging unit 44. This transmission data is not contents transmitted in the transmission packet. However, the transmission data is equivalent to transmission data planned to be transmitted when a CTS packet is returned in response to the RTS packet, which is the transmission packet.

The header-information updating/storing unit 41 cumulatively adds up the duration information calculated by the duration calculating unit 42 and generates and stores header information of the packet, for example, holds transmission duration (TXOP) obtained according to the RTS. The transmission duration is stored in a Duration field of the RTS frame.

The transmission-possibility judging unit 44 judges whether the transmission data outputted from the transmission buffer list 22 in the packet may be transmitted at this transmission opportunity. When it is judged that it is possible to transmit the transmission data as a processing object with the packet, the transmission-possibility judging unit 44 instructs the address counter 43 to read out the next transmission data from the transmission buffer list 22. Conversely, when it is judged that it is difficult to transmit the transmission data as a processing object with the packet, the transmission-possibility judging unit 44 determines to form a transmission packet using data up to transmission data immediately preceding the transmission data and finishes processing for generating header information.

When the length of an entire transmission packet exceeds an allowable maximum value given by a parameter, transmission duration exceeds an allowable maximum value given by a parameter, or the number of transmission data exceeds a maximum allowable value given by a parameter, the transmission-possibility judging unit 44 judges that it is difficult to transmit the transmission data with the packet. The transmission-possibility judging unit 44 also finishes the processing for generating header information when it is judged that no more transmission data is stored according to information obtained from the transmission buffer list 22.

Since the processing is simultaneously executed by plural processing circuit modules, it is possible to complete the processing in one cycle for one transmission data. In other words, after initialization, it is possible to execute processing concerning N transmission data in N cycles. In the example of the state shown in FIG. 3, processing for transmission data is completed once in S06, S16, S26, and the like and X−1 (when there is no more transmission data, X) transmission data are finally transmitted.

When the processing for generating header information concerning all transmission data as transmission objects is finished, the processing for generating header information is finally finished through processing for determining final header information and storing a result of the processing in the header-information updating/storing unit 41 (S07).

The invention has been explained in detail with reference to the specific embodiment. However, it is obvious that those skilled in the art can perform modification and alteration of the embodiment without departing from the spirit of the invention.

In this specification, the embodiment of the invention has been explained mainly about the application of the invention to IEEE802.11, which is the representative standard of the wireless LAN system. However, the gist of the invention is not limited to this. It is possible to apply the invention to communication systems of other packet switching systems in the same manner. Also, the subject to which the invention is applicable is not limited to a particular medium and the invention can be applied to wireless and wired systems.

The invention has been described by way of example and it should not be construed to be limited to the disclosure in the specification. To judge the gist of the invention, the appended claims have to be taken into account.

It should be understood by those skilled in the art that various modifications, combinations, sub-combinations, and alterations may occur depending on design requirements and other factors insofar as they are within the scope of the appended claims or the equivalents thereof.

What is claimed is:

1. A communication apparatus that performs data transmission on a medium according to the packet switching system, the communication apparatus comprising:
an upper-layer processing unit that performs processing of data to be transmitted;
a Phy processing unit that manages an operation of physical access to the medium; and
a media-access-control processing unit that generates a transmission packet, instructs the Phy processing unit to transmit the packet, and performs control for access to the medium, wherein
the media-access-control processing unit includes:
a buffer memory that temporarily stores the transmission data, which the upper-layer processing unit requests to transmit;
a transmission buffer list that holds attribute information concerning respective transmission data stored in the buffer memory; and
header-information generating means for generating header information of the transmission packet with reference to the transmission buffer list, and
the media-access-control processing unit instructs the Phy processing unit to transmit a preamble signal according to storage of the transmission packet in the buffer memory or a transmission instruction from the media-access-control processing unit, starts generation processing for the header information by the header-information generating means, and instructs the Phy processing unit to transmit, before the transmission of the preamble signal is finished, the header information generated.

2. A communication apparatus according to claim 1, wherein the transmission buffer list holds at least one of types of a destination address, a transmission data rate, and a packet format as the attribute information of the transmission data.

3. A communication apparatus according to claim 2, wherein
the communication apparatus is applied to a communication system to which a CSMA/CA system by a RTS/CTS procedure is applied,
the media-access-control processing unit includes a protocol processing unit that analyzes types of a reception packet and a transmission packet, and
the protocol processing unit determines type information of the transmission packet when the media-access-control processing unit instructs the Phy processing unit to transmit a preamble signal.

4. A communication apparatus according to claim 2, wherein
the communication apparatus is applied to a communication system to which a CSMA/CA system is applied,
the transmission buffer list holds a data length as attribute information of the transmission data,
the media-access-control processing unit further includes duration calculating means for calculating duration necessary for a transmission operation for the transmission data on the basis of the transmission data rate and the data length, and
the header-information generating means describes media reservation information (Duration) used for access using the CSMA/CA as a part of the header information on the basis of a result of the calculation by the duration calculating means.

5. A communication apparatus according to claim 2, wherein, in multiplexing contents of two or more transmission data on one packet,
the duration calculating unit calculates duration every time transmission data is added,
the header-information generating means cumulatively adds up data lengths of respective transmission data multiplexed on the packet and updates contents of the header information on the basis of a result of the calculation by the duration calculating means.

6. A communication method of performing data transmission on a medium according to a packet switching system, the communication method comprising the steps of:
temporarily storing transmission data, which an upper layer requests to transmit, in a buffer memory;
holding attribute information concerning respective transmission data, which are stored in the buffer memory, in a transmission buffer list;
instructing a Phy processing layer to start transmission of a preamble section of a packet according to storage of the transmission data in the buffer memory;
generating header information of the transmission packet with reference to the buffer list; and
instructing the Phy processing layer to transmit, before transmission of a preamble signal is finished, the header information generated.

7. A computer program product for a communication method of performing data transmission on a medium according to a packet switching system, the computer program product causing a computer to execute processing comprising the steps of:
temporarily storing transmission data, which an upper layer requests to transmit, in a buffer memory;
holding attribute information concerning respective transmission data, which are stored in the buffer memory, in a transmission buffer list;
instructing a Phy processing layer to start transmission of a preamble section of a packet according to storage of the transmission data in the buffer memory;
generating header information of the transmission packet with reference to the buffer list; and
instructing the Phy processing layer to transmit, before transmission of a preamble signal is finished, the header information generated.

8. A communication apparatus that performs data transmission on a medium according to the packet switching system, the communication apparatus comprising:
an upper-layer processing unit that performs processing of data to be transmitted;
a Phy processing unit that manages an operation of physical access to the medium; and
a media-access-control processing unit that generates a transmission packet, instructs the Phy processing unit to transmit the packet, and performs control for access to the medium, wherein
the media-access-control processing unit includes:
a buffer memory that temporarily stores the transmission data, which the upper-layer processing unit requests to transmit;
a transmission buffer list that holds attribute information concerning respective transmission data stored in the buffer memory; and
header-information generating means for generating header information of the transmission packet with reference to the transmission buffer list, and
the media-access-control processing unit instructs the Phy processing unit to transmit a preamble signal according to storage of the transmission packet in the buffer memory or a transmission instruction from the media-access-control processing unit, starts generation processing for the header information by the header-information generating means, and instructs the Phy processing unit to transmit, before the transmission of the preamble signal is finished, the header information generated.
